(19) United States
(12) Patent Application Publication
(10) Pub. No.: US 2017/0052774 A1
(43) Pub. Date: Feb. 23, 2017

(54) USER ACQUISITION VIA BIDDING FOR CONNECTED DEVICE APP INSTALLS

(71) Applicant: Google Inc., Mountain View, CA (US)

(72) Inventor: Madan Swamygowda Ankapura, Fremont, CA (US)

(21) Appl. No.: 14/829,130

(22) Filed: Aug. 18, 2015

(51) Int. Cl. G06F 9/445; G06F 3/0482; G06F 3/0484; G06Q 20/12

(52) U.S. Cl. CPC G06F 8/61; G06Q 20/123; G06F 3/0482; G06F 3/04842

(57) ABSTRACT

A system and method to provide a single intermediary agent which may identify user devices that are available for application installation, aggregate user devices to facilitate a single selection operation for the application installation and/or presentation of an application icon at a specific location of a screen display on the aggregated user devices, perform a selection operation between one or more application providers for application installation and icon placement on the aggregated user devices, and direct a group-wide installation and icon placement of an application on the aggregated user devices in response to a successful selection operation by an application provider. The acquisition revenue generated by the successful selection operation may be directed, by the intermediary agent, from the application provider to the participating device partners, including OEMs and cellular carriers of the aggregated devices, minus a percentage retained by the intermediary agent.

### BACKGROUND

In the mobile communication and computing arena, individual portable computing devices (e.g., smart phones, tablet computers, laptop computers, and the like) can be provided with, or users can download and install, small specialized applications, or “apps”, to perform specific functions or engage in particular activities. Such functions and activities range from playing games and sharing photographs, to banking and finding real estate properties. As used herein, the term application may refer to any type of standalone or Internet connected application, program, or subroutine executed in any layer in the computing environment (e.g., in the operating system, in the middleware layer, or as a top layer application), including mobile applications.

Device partners, such as Original Equipment Manufacturers (OEMs), cellular carriers, and the like, often provide devices with such applications pre-installed, and digital distribution markets provide users with the opportunity to purchase any number of such applications or replacement applications for their mobile devices thereafter. In this regard, the usual workflow for application search, discovery and purchase, such as to obtain a game application for example, typically begins when a user searches the market with a categorical query of interest (e.g., “action games”), and selects one or more interesting results. The user then analyzes the application details, user reviews, screenshots and other related content and if satisfied, downloads the application. The user can open and load the application, and setup the application to a working and representative state (i.e., get through menus, loading screens, account setup, tutorials, and so forth). The user can then test the application and if not satisfied with the test results, can either stop searching or return to at least the search process to look for alternative applications. The user can also remove an application if not satisfied with the application, and return to at least the search process to look for alternative applications. However, user acquisition may present a number of problems for application providers, even during a growth phase of upwards of several million users in the user device market.

### BRIEF SUMMARY

An implementation of the disclosed subject matter provides a system and method that may identify user devices that are available for application installation, aggregate user devices to facilitate a single selection operation for application installation on the aggregated user devices, perform a selection operation between one or more application providers for application installation, and direct a group-wide installation of an application on the aggregated user devices in response to a successful selection operation by an application provider. The acquisition revenue generated by the successful selection operation may be directed, by the intermediary agent, from the application provider to the participating device partners, including OEMs and cellular carriers of the aggregated devices, minus a percentage retained by the intermediary agent.

To do so, an implementation of the disclosed subject matter may provide an intermediary agent to identify user devices that are available for application installation. In one implementation, user devices that are available for selection operations, and what parameters to be considered in order to select applications for the available user devices, may be integrated into the software on the user devices and be accessed by the intermediary agent.

An implementation of the disclosed subject matter may also provide the intermediary agent to aggregate the user devices to facilitate a single selection operation for application installation on the aggregated user devices. In one implementation, the intermediary agent may aggregate the user devices based on user profile, device types or other aspects or combinations thereof.

An implementation of the disclosed subject matter may also provide a platform for performing the selection operation between one or more application providers for application installation on the aggregated user devices. The intermediary agent can communicate with a number of application providers that are interested in providing an application for installation on the aggregated user devices. In one implementation, the selection operation can be a bidding operation, where one or more application providers bid for application installation, and where the highest or otherwise most desirable bid by one or more of the application providers (i.e., a successful selection operation) results in the installation of the application of the application provider on the aggregated user devices.

An implementation of the disclosed subject matter may also provide a system and method to divide a screen display of the user devices, and provide a platform for performing the selection operation between one or more application providers for installation of their application and presentation of their application icon at a specific location or region of a screen display of the aggregated user devices, in a single operation.

An implementation of the disclosed subject matter may also direct a group-wide installation of the application on the aggregated user devices in response to the successful selection operation by the application provider.

An implementation of the disclosed subject matter may also direct the acquisition revenue generated by the successful selection operation from the application provider to the participating device partners, including OEMs and cellular carriers of the aggregated devices, minus a percentage retained by the intermediary agent.

An implementation of the disclosed subject matter may also direct the intermediary agent to detect user devices that are available for application installation due to reservation or application removal by the user, perform a similar selection operation for the available application installation, and restrict from the selection operation an application and/or related application previously installed.

An implementation of the disclosed subject matter may also direct the intermediary agent to detect an application preference type for the application installation, perform a similar selection operation for the application installation, and restrict from the selection operation an application that does not conform to the application preference type for the application installation.

Accordingly, implementations of the disclosed subject matter may identify user devices that are available for application installation, aggregate user devices to facilitate a single selection operation for the application installation and/or presentation of an application icon at a specific location of a screen display on the aggregated user devices, perform a selection operation between one or more application providers for application installation and icon placement on the aggregated user devices, and direct a group-wide installation and icon placement of an application on the aggregated user devices in response to a successful selection operation by an application provider. The acquisition revenue generated by the successful selection operation may be directed, by the intermediary agent, from the application provider to the participating device partners, including OEMs and cellular carriers of the aggregated devices, minus a percentage retained by the intermediary agent.

Implementations of the disclosed subject matter can also provide a single intermediary agent to manage installation of applications on a user device. The intermediary agent may identify user devices that are available for application installation, and provide a platform for performing a selection operation between one or more application providers for application installation. The intermediary agent may aggregate user devices to facilitate a single selection operation for the application installation and/or presentation of an application icon at a specific location of a screen display on the aggregated user devices, and direct a group-wide installation and icon placement of an application on the aggregated user devices in response to a successful selection operation by an application provider. The acquisition revenue generated by the successful selection operation is directed, by the intermediary agent, from the application provider to the participating device partners, including OEMs and cellular carriers of the aggregated devices, minus a percentage retained by the intermediary agent. In doing so, the application providers may negotiate solely with the intermediary agent for installation of an application on an aggregated number of end user devices and acquisition revenue generated by the successful selection operation may be directed from the application provider to the participating device partners by the intermediary agent.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of the disclosed subject matter. No attempt is made to show structural details in more detail than may be necessary for a fundamental understanding of the disclosed subject matter and various ways in which it may be practiced.

FIG. 1 shows an illustrative system to manage installation of applications on a user device, according to an implementation of the disclosed subject matter.

FIG. 2 is an illustrative home screen, according to an implementation of the disclosed subject matter.

FIG. 3 is an illustrative flowchart depicting operations for controlling an intermediary agent to manage installation of applications on a user device, according to an implementation of the disclosed subject matter.

### DETAILED DESCRIPTION

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, and so forth. In other instances, well-known structures and devices are shown in block diagram form to facilitate describing the subject disclosure.

As previously disclosed, systems and methods that provide an ability for an application provider to negotiate the effective and efficient installation of applications on devices such as mobile devices may be advantageous. Further, it may be desirable for such installation to be independent of, or to operate similarly, across devices from multiple sources and providers such as OEMs and cellular carriers. Described herein are techniques to improve the distribution and installation of applications on devices. According to implementations disclosed herein, an intermediary agent may be used to identify end user devices that are available for application installation, then aggregate end user devices to facilitate a single selection operation for application installation on the aggregated user devices. The intermediary agent may perform, manage or otherwise support a selection operation between one or more application providers for the application installation on the aggregated user devices, and direct a group-wide installation of an application and/or presentation of an application icon at application icon placement locations on the aggregated end user devices in response to a successful selection operation by an application provider. In some implementations, acquisition revenue generated by a successful selection installation may be apportioned by the intermediary agent among the participating device partners, including OEMs and cellular carriers of the aggregated devices, and/or a percentage may be retained by the intermediary agent. In doing so, the application providers may negotiate solely with the intermediary agent for installation of an application on an aggregated number of end user devices. Acquisition revenue generated by the successful selection operation may be directed from the application provider to the participating device partners by the intermediary agent. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

Implementations of the disclosed subject matter may provide a system and method for an application provider to bid for the installation of their application on an arbitrarily large number of end user devices in a single operation without requiring separate and/or numerous negotiations with participating device partner providers of the aggregated devices. Such a bidding process may include, for example, any suitable form of auction, or other forms of offer and acceptance of a particular offer related to installation and/or placement of an application on end user devices. To better identify end user devices for such installation, implementations of the disclosed subject matter may aggregate groups of end user devices, including groups based on user profile aspects, device types or other aspects or combinations thereof, such that the application provider may bid for the installation of their application on end user devices that share one or more characteristics that indicate that the end user devices are most likely to use the application, in a single operation. Implementations of the disclosed subject matter may further divide a screen display into various locations or regions, such that the application provider may bid for the installation of their application and presentation of their application icon at a specific location or region of a screen display of the aggregated user devices, in a single operation.

In the following description, reference is made to device partners, which may include but is not limited to any entity in position to pre-install or direct later installation of an application on a user device, such as OEMs and cellular carriers, with or without payment from an application provider. Also in the following description, reference is made to application providers, which may include but is not limited to any developer or other entity that wishes to provide or market an application to an end user device.

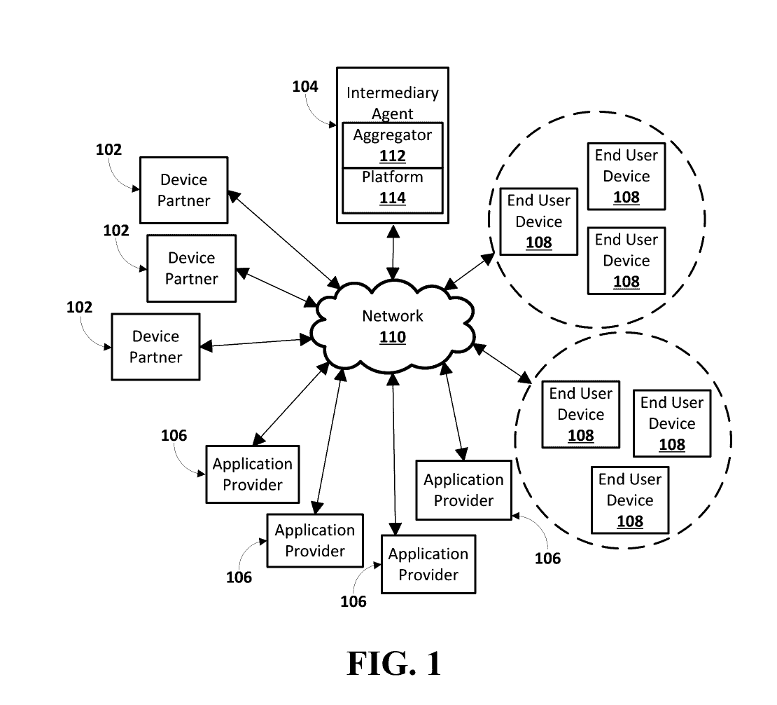

FIG. 1 shows an illustrative system to manage installation of applications on a user device, according to an implementation of the disclosed subject matter. The system of FIG. 1 may include device partners 102, an intermediary agent 104, application providers 106, end user devices 108 and a network 110. The intermediary agent 104 may further include an aggregator 112 and selection operation platform 114. The device partners 102 may include but are not limited to, any entity in position to pre-install or direct later installation of an application on the end user devices 108, such as OEMs and cellular carriers, with or without payment from the application providers 106. The end user devices 108 may be aggregated into any number of groups and sub-groups, such as the two groups shown in FIG. 1 for illustration purposes. The end user devices 108 may be aggregated into groups in which members of the group share one or more characteristics that indicate that the group of end user devices are most likely to use the application in comparison with other end user devices. The end user devices 108 may be aggregated based on user profile aspects (e.g., location, age, interest, other applications, and so forth), device types, or other aspects or combinations thereof, such that the application providers 106 may bid for the installation of their application on a specific, aggregated number of end user devices 108 that are most likely to use the application, in a single operation.

In this case, aggregation may be one tool to bundle end user devices 108 in a manner that can maximize the value of the application icon placement locations and simplify the selection of end user devices for application installation. The aggregation of end user devices may maximize their value to the application providers 106 by ensuring that the end user devices share an interest in an application or types of applications that indicates that the end user devices are likely to use the application. The aggregation of end user devices may also maximize their value to the device partners 102 by increasing the number of end user devices participating in the acquisition for application installation. For each selection operation, the single acquisition fee may be based on the number of end user devices participating in the acquisition for application installation. Accordingly, a larger number of end user devices in each selection operation increases the single acquisition fee received by the device partners 102. Further, aggregation of end user devices can allow an application to be installed on the entirety of the aggregated end user devices (i.e., a group-wide installation) in response to the single selection operation.

The device partners 102, intermediary agent 104, application providers 106 and end user devices 108 may be configured to communicate with one another via network 110 and/or various types of electronic communication protocols including, but not limited to, Wi-Fi, general packet radio service (GPRS), global system for mobile communications (GSM), enhanced data rates for GSM evolution (EDGE), 3G, 4G, 4G long-term expansion (LTE), worldwide interoperability for microwave access (WiMAX), Ethernet, the Internet, and other wireless and wired electronic communication protocols.

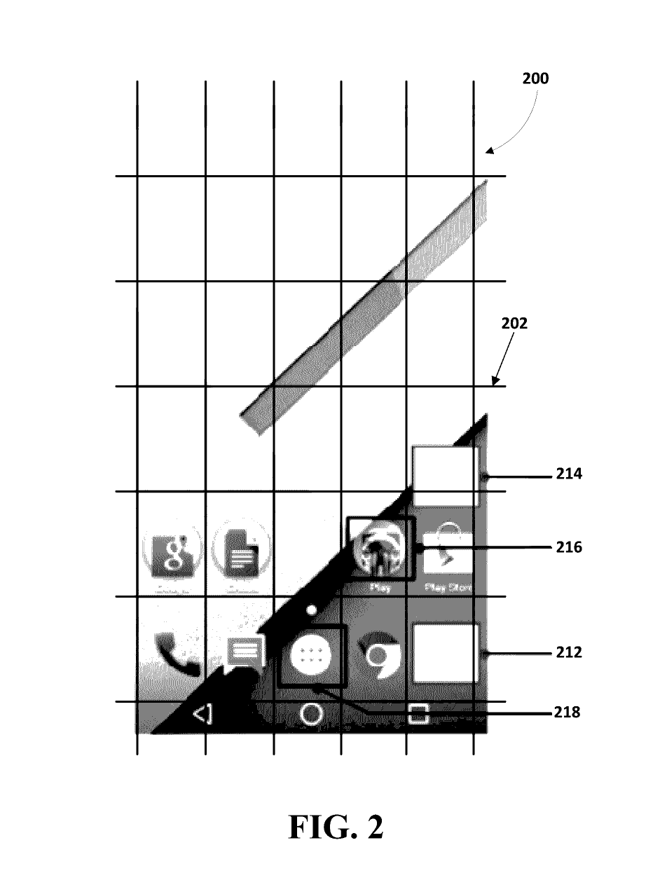

The end user devices 108 may include a smartphone, tablet device, laptop, set-top box, watch, eye-glasses, or other computer systems, and may locally execute applications using a local processor and memory. Such memory may include volatile and non-transitory computer readable media in the device. The end user devices 108 may further include various types of standardized or specialized user interface devices, such as touchscreens, keyboards, computer displays, voice (microphone/speaker), cameras, keyboards, proximity sensors, mice, styli, and so forth, and may further include graphical user interface (GUI) generators for displaying GUIs on each device. As further illustrated in FIG. 2, the end user devices 108 may further include the display to provide a “screen” display. A “homescreen” is one example of a “screen” display that can be provided and typically includes the introductory visual interface displayed on a device or computer program, from which a user is able to access particular functions. FIG. 2 is an illustrative homescreen, according to an implementation of the disclosed subject matter.

In an implementation of the disclosed subject matter, the application providers 106 may also bid for the presentation of their application icon at a specific location on the screen display of the aggregated user devices 108 in the same single selection operation or in a separate selection operation. For example, a screen display such as the homescreen display of the end user devices 108, may be divided into multiple locations, such that the application providers 106 may bid for the installation of their application and presentation of their application icon at a specific location of the homescreen of the aggregated end user devices 108 in a single selection operation. In this case, one shared characteristic of aggregated devices 108 may be common locations that are available for presentation of application icons, e.g., devices with available locations at the top right area of the homescreen.

Homescreen 200 in FIG. 2 shows a number of application icon placement locations that may be found on an end user device and more specifically, a number of application icon placement locations that may be found on the aggregated end user devices 108. The application icon placement locations may include a hierarchy of spatially dispersed application icon placement locations on a user device display, where some locations on the user device display are more desirable to application providers than other locations on the user device display. For example, locations in the lower, right side of the homescreen 200 may be more desirable to application providers due to the user tendency to use icons of such positions more frequently. Accordingly, locations in the lower, right side of the homescreen 200 may be more valuable to application providers and expect to achieve a greater acquisition price in the selection operation. Thus, end user devices 108 with available installation locations in the lower right side of the homescreen 200 may be aggregated into a group. The end user devices of this group may be further aggregated based on user profile aspects (e.g., location, age, interest, other applications, and so forth), device types or other aspects or combinations thereof. In the case of an auction or similar selection operation, a higher reserve may be applied to such locations when the application providers 106 bid for the installation of their application at those locations on the homescreens of the aggregated end user devices 108.

As another example, in some cases locations in the upper, right side of the homescreen 200 may be less desirable to application providers due to the user tendency to use icons of such positions less frequently. Accordingly, locations in the upper, right side of the homescreen 200 may be less valuable to application providers and expect to achieve a lesser acquisition price in the selection operation. In the case of an auction or similar operation, a lower reserve may be applied to such locations, or the locations may be combined with other locations, when the application providers 106 bid for the installation of their application at those locations on the homescreens of the aggregated end user devices 108.

In one implementation of the disclosed subject matter, a grid division 202 may be applied to the homescreen 200 to identify application icon placement locations on an end user device 108 (e.g., using identifying row and column numbers and/or identifiers such a “dock” icons and “hotseat” icons), where some locations are more desirable to application providers than other locations. Such a homescreen 200 and grid division 202 thereof in FIG. 2 is provided for illustration purposes, and implementations of the disclosed subject matter are not limited thereto.

In addition to unoccupied application icon placement locations on the homescreen 200, a number of application icons are shown in some remaining application icon placement locations, to illustrate a typical end user device and the various acquisition values that may be associated with each location. As noted above, the application providers 106 may bid for the presentation of their application icon at a specific location on the homescreen 200 of the aggregated user devices 108 in the single operation. The application icon placement locations may include application icon placement locations on the homescreen 200 of the aggregated user devices 108, where some locations are more desirable to application providers than other locations on the user device display. The more desirable locations are available at higher acquisition costs and accordingly, generate greater acquisition revenue for the device partners 102. The following is an illustration of acquisition costs that may be associated with icon placement locations on the homescreen 200 of the aggregated user devices 108, but implementations of the disclosed subject matter are not limited thereto.

In an implementation in which an application provider may bid for a specific location on homescreens of aggregated user devices 108 for presentation of their application icon, a “hotseat” icon position 212, may be acquired at a higher acquisition cost than remaining application icon placement locations. As noted above, in some cases locations in the lower, right side of the homescreen 200 may be more desirable to application providers 106 due to the user tendency to use icons of such positions more frequently. Accordingly, locations in the lower, right side of the homescreen 200 may be more valuable to application providers 106 and expect to achieve a greater acquisition price.

A “homescreen” icon position, such as position 214, may be acquired at an acquisition cost that may be lower than the acquisition cost for icon position 212 but higher than an acquisition cost for the remaining application icon placement locations. A “folder” icon position, such as position 216, may be acquired at an acquisition cost that may be lower than the acquisition cost for icon position 214 but greater than an acquisition cost for the remaining application icon placement locations. An “installation” icon position, such as position 218, may be acquired at an acquisition cost that may be lower than the acquisition cost for icon position 214 but greater than an acquisition cost for the remaining application icon placement locations. A further amount may be charged for a first use of an application, or some other occurrence-type criteria, such as a first purchase of a product through use of the application and so forth. The icons, application icon placement locations and acquisition costs of FIG. 2 are for illustration purposes, and implementations of the disclosed subject matter are not limited thereto. Further, at the time of sale, factory icon images may be provided in some display locations with no knowledge or indication of an application later occupying the location, without affecting the function of the implementations described herein. The specific relative bid or cost ranges disclosed above and elsewhere herein are provided for illustration only, and it will be understood that the relative costs in a specific implementation of the presently disclosed subject matter may vary based on, for example, application icon placement conventions for particular devices or types of devices, known user preferences, developer or other application provider preferences, or the like.

After the homescreen 200 of the end user device 108 has been divided as desired, the aggregator 112 of the intermediary agent 104 may perform an aggregation of the end user devices 108 into groups based on the available display locations. The end user devices of each group may be further aggregated based on user profile aspects (e.g., location, age, interest, other applications, and so forth), device types, or other aspects or combinations thereof. These and other aggregations in this manner can allow a single selection operation for an application installation and application icon placement location on each device of the aggregated end user devices 108. That is, aggregation may be used as one tool to bundle end user devices 108 in a manner that may maximize the value of the application installation and application icon placement location, and simplify selection and installation of the application and application icon on an entire bundle (i.e., group) of end user devices 108.

The intermediary agent 104 may further include the selection operation platform 114 which allows the device partners 102 to participate in a selection operation permitting installation of applications and presentation of application icons at locations on the homescreens of the aggregated end user devices 108, and allows the application providers 106 to bid for the installation of their applications and presentation of their application icons at the locations on the homescreens of the aggregated end user devices 108. The device partners 102 are allowed to participate in the selection operation thereby agreeing to advise the intermediary agent 104 of end user devices and/or screen divisions that are available for application installation and application icon placement. The participating device partners 102 may further advise the intermediary agent 104 of other information that may be used to identify and aggregate end user devices and/or screen divisions. The participating device partners 102 may further agree to perform application installations and presentations of application icons at locations on the homescreens of the aggregated end user devices 108 in response to successful selection operations. A server side configuration may also be provided to turn any of these features off and on when desirable to do so, without affecting the function of the implementations described herein.

In return for the participation by one or more device partners 102, the intermediary agent 104 may direct a payment or payments from the application provider 106 to the device partners 102. In some cases, a percentage of an initial payment may be retained by the intermediary agent 104 in response to successful selection operations. In addition to participating in the selection operation, the device partners 102 may also impose a number of restrictions to the resulting selection operation carried out by the intermediary agent 104. For example, in one implementation of the disclosed subject matter, the device partners 102 may modify a launcher program to show information regarding selection operation-type applications and application providers (e.g., information noting than an application on the device is the result of a selection operation). In another implementation of the disclosed subject matter, the device partners 102 may identify applications that have been previously removed from an end user device, such that the application and/or similar applications may be restricted from reinstallation. In another implementation of the disclosed subject matter, the device partners 102 may identify preference attributes of applications and locations on the homescreens of the end user devices 108, such that applications considered for selection conform to the preferences identified by the device partners 102.

The selection operation platform 114 also allows the application providers 106 to participate in the selection operation for the application installation and application icon placement locations of the aggregated end user devices 108, including but not limited to, an auction-type selection operation between the participating application providers 106. As previously indicated, any suitable bidding or other competitive or non-competitive techniques may be used to allow application providers to bid for specific placement locations or regions on end user device displays. For example, a bidding process may allow each application provider to submit a proposed price for one or more desired locations, and a highest price may be selected for each location. As another example, application providers may submit a price and an indication of the type of application for which they are bidding on a particular location, and a set of applications may be selected such that applications having a price above a threshold are selected while not selecting more than one application of the same type for display on the same region or entirety of a display. If a resulting bid of an auction is zero or fails to meet a threshold, then other metrics including application desirability and similarity to existing applications may be considered, and the weights of such metrics may be varied or reconsidered over time. Other auction processes, weighing techniques, and selection processes may also be used.

The application providers 106 may be allowed to join the selection operation thereby agreeing to participate and, if successful, pay the intermediary agent 104 for an application installation and/or presentation of an application icon at a location on the homescreens of the aggregated end user devices 108. In return, the intermediary agent 104 directs the participating device partners 102 to perform application installation and/or presentation of the application icon at locations on the homescreens of the aggregated end user devices 108. The intermediary agent 104 may also direct payment or payments from the application provider 106 to the participating device partners 102, minus a percentage retained by the intermediary agent 104.

As noted above, the device partners 102 may include but are not limited to any entity in position to pre-install or direct later installation of an application on an end user device. To facilitate later installation of an application on a user device, the device partners 102 may include launcher support for application placeholders, or application icon placement location placeholders. The application installation and application icon placement locations that are available for selection operations, and what parameters to be considered in order to select applications for the available application installation and application icon placement locations, may be integrated into software on the end user devices and accessed by the intermediary agent 104, or provided to the intermediary agent 104 by the device partners 102 when, for example, the device partners 102 participate in the selection operation. In one implementation of the disclosed subject matter, the device partners 102 may provide tagged or otherwise labeled application icon placement locations of the screen display identifying “app bid” placeholder locations on the homescreens 200 of the end user devices 108.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the intermediary agent 104. The user may also choose not to participate in any part of the identification, aggregation, selection operation and subsequent application installation and/or presentation of an application icon at a location on the homescreen of the end user device. Where the user wishes to participate, the user can set a device profile to limit the amount and kind of information that is shared with the intermediary agent 104 and other devices. The intermediary agent 104 may use encryption processes to further ensure privacy, anonymity and security of data regarding each end user device 108.

In response to a successful selection operation by an application provider 106, the intermediary agent 104 may direct the installation of an application and/or presentation of an application icon at a location on the display screen of the aggregated end user devices 108. The device partners 102 and/or intermediary agent 104 may distribute the application to the aggregated end user devices 108 in response to the successful selection operation by an application provider 106. In one implementation of the disclosed subject matter, the intermediary agent 104 and/or device partners 102 integrate the winning bid with a system such as an automatic installation or update service to direct the installation of the application and/or presentation of the application icon at the location on the display screen of the aggregated end user devices 108.

In further response to the successful selection operation by an application provider 106, the intermediary agent 104 may direct a payment or payments from the application provider 106 to the device partners 102, minus a percentage retained by the intermediary agent 104. The payment may be conducted in any number of secured exchanges known to those skilled in the art. As noted above, in one implementation of the disclosed subject matter, a total acquisition fee paid by a successful application provider 106 for the installation of an application and the presentation of an application icon at a location on the display screen of the aggregated end user devices 108, may be based upon the acquisition cost of the location on the display screen multiplied by the total number of aggregated end user devices 108 participating in the selection operation, but is not limited thereto.

The percentage of the payment or payments from the application provider 106 that may be retained by the intermediary agent 104 may be based on the successful selection operation amount total, the number of application providers 106 participating in the selection operation, the number of device partners 102 participating in the selection operation, the number of aggregated end user devices 108 participating in the selection operation, or some combination thereof, but is not limited thereto. Further, the intermediary agent 104 may provide additional features upon completion of the successful selection operation, such as regulatory-compliant logging for 3rd party applications and device partners. The additional features may be provided at no cost, or may be provided at additional cost to one or both of the participating device partners 102 and the application provider 106.

The intermediary agent 104, including the aggregator 112 and selection operation platform 114 may include or be embodied in the form of computer-implemented processes and apparatuses for practicing those processes. Implementations also may be embodied in the form of a computer program product having computer program code containing instructions embodied in non-transitory and/or tangible media, such as hard drives, USB (universal serial bus) drives, or any other machine readable storage medium, such that when the computer program code is loaded into and executed by a computer, the computer becomes an apparatus for practicing implementations of the disclosed subject matter. When implemented on a general-purpose microprocessor, the computer program code may configure the microprocessor to become a special-purpose device, such as by creation of specific logic circuits as specified by the instructions.

The intermediary agent 104, including the aggregator 112 and selection operation platform 114 may include or be implemented using hardware that may include a processor, such as a general purpose microprocessor and/or an Application Specific Integrated Circuit (ASIC) that embodies all or part of the techniques according to the disclosed subject matter in hardware and/or firmware. The processor may be coupled to memory, such as RAM, ROM, flash memory, a hard disk or any other device capable of storing electronic information. The memory may store instructions adapted to be executed by the processor to perform the aggregation and selection operation techniques according to the disclosed subject matter.

Implementations of the disclosed subject matter may perform the selection operation to permit the device partners 102 to pre-install the application on the aggregated user devices 108 in response to the successful selection operation by an application provider 106. In the case where the selection operation occurs at a later time, either because the application icon placement location is available, has been reserved or because the application icon placement location has become available due to a user removing an application, the location may be identified for a subsequent selection operation. In this case, the location may be identified for the subsequent selection operation with the exception of a selection operation resulting in the reinstallation of the removed application and/or a related application.

For example, in one implementation of the disclosed subject matter, once an application has been identified as previously removed from an end user device 108, the application and/or similar applications may be restricted from reinstallation or replacement. As part of this identification, implementations of the disclosed subject matter may also identify and provide attributes of the end user device or locations on the display of the end user device that can be used to select or identify applications from a number of available applications for participation in the selection operation. For example, an application icon placement location or newly available location of the aggregated end user devices 108 may have a preference attribute, such as a location that is reserved for only music applications. Also, where a user shows a preference for an application type (e.g., shopping type, music type, sports type and so forth), such applications and related applications may be given a preference attribute based thereon. Such attributes may be considered when identifying applications for participation in the selection operation. Such attributes may also be considered in the aggregation of end user devices, or in the filtering or identification of application providers to participate in the selection operation, and ensure that end user preferences are incorporated in the selection operation. The filtering or identification of application providers participating in the selection operation, or limiting applications considered for installation to only those published at one or more application stores, also ensures that misuse of the selection operation is avoided.

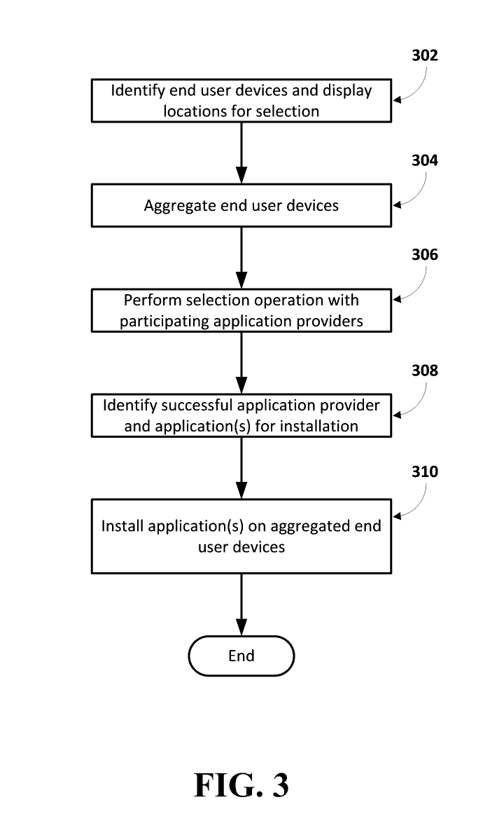

FIG. 3 is an illustrative flowchart depicting operations for controlling an intermediary agent 104 to manage installation of applications on aggregated end user devices 108 according to an implementation of the disclosed subject matter. The described operations may be accomplished using one or more of elements described herein and in some implementations, various operations may be performed in different sequences. In other implementations, additional operations may be performed along with some or all of the operations shown in FIG. 3. In yet other implementations, one or more operations may be performed simultaneously and/or one or more operations may not be performed. Accordingly, the operations described should not be viewed as limiting.

In operation 302, the device partners 102 ensure that selection, bidding or other similar operations (e.g., quantity and other identifying aspects of application icon placement locations) are described and integrated into software on the end user devices and accessible by the intermediary agent 104, such that one or more end user devices and application icon placement locations on end user devices are identified for participation in a selection operation. Since some application icon placement locations are more desirable than other locations, the identification of the application icon placement locations may be identified as illustrated in the homescreen 200 of FIG. 2. In an implementation of the disclosed subject matter, any portion of the user device display can be divided into portions and further divided into sub portions to identify potential application icon placement locations as described in regard to FIG. 2. In doing so, each application icon placement location on an end user device is readily identifiable and equally represented among end user devices 108 having same or substantially similar user device displays.

In operation 304, the intermediary agent 104 performs an aggregation of the end user devices 108. The aggregator 112 of the intermediary agent 104 may aggregate end user devices 108 into groups based on the available application icon placement locations, and may further aggregate the end user devices of each group based on user profile aspects (e.g., location, age, interest, other applications, and so forth), device types, or other aspects or combinations thereof. As noted above, aggregation techniques as disclosed herein may bundle end user devices 108 in a manner that maximizes or improves the value of the application installation and application icon placement locations, and/or simplifies the selection and installation of the application and application icon on the entire bundle of end user devices 108. The aggregation of end user devices may improve or maximize their value to the application providers 106 by ensuring that the aggregation of end user devices 108 share an interest in an application or types of applications, and maximizes their value to the device partners 102 by increasing the number of end user devices participating in the acquisition for each icon placement location. Further, aggregation of end user devices 108 allows an application to be installed on the entirety of the aggregated end user devices 108 in response to the single selection operation.

In operation 306, the application providers 106 bid or otherwise participate in a selection operation for the application installation and various application icon placement locations on the homescreen 200 of the aggregated end user devices 108. The intermediary agent 104 includes the selection operation platform 114 which allows the device partners 102 to participate in the selection operation permitting installation of applications and placement of application icons at locations on the homescreens 200 of the aggregated end user devices 108, and allows the application providers 106 to bid for the installation of their application and placement of application icons at desired locations on the homescreens 200 of the aggregated end user devices 108 in a single selection operation.

The participating application providers 106 can be filtered, or permitted in the selection operation, in any number of ways. For example, once an application has been identified as previously removed from an end user device 108, the application and/or similar applications may be restricted from reinstallation or replacement. Where an application icon placement location or newly available location of the aggregated end user devices 108 has a preference attribute, like a location that is reserved for only music applications, or where a user shows a preference for an application type, such applications and related applications may be given a preference attribute when identifying applications for participation in the selection operation. Such attributes may also be considered in the aggregation of end user devices 108 for participation in the selection operation, and in filtering or identification of application providers 106 for participation in the selection operation.

The intermediary agent 104 may then execute the selection operation, including but not limited to, an auction-type selection operation between the participating application providers 106, and the details of the successful selection operation are identified at operation 308. Upon completion of the selection operation by the application provider 106, the intermediary agent 104 may direct a payment from the successful application provider 106 to the participating device partners 102, minus a percentage retained by the intermediary agent 104. The payment can be conducted in any number of secured exchanges known to those skilled in the art. The percentage of the payment or payments from the application provider 106 retained by the intermediary agent 104 can be based on the successful selection amount total, the number of application providers 106 participating in the selection operation, the number of device partners 102 participating in the selection operation, the number of aggregated end user devices 108 participating in the selection operation or some combination thereof as previously described, but is not limited thereto.

In step 310, the successful application provider 106 may identify and/or provide the application(s) and/or application icon(s) to be installed on the aggregated end user devices 108 and at the application icon placement locations of the display screens of the aggregated end user devices 108. In one implementation of the disclosed subject matter, the intermediary agent 104 and/or device partners 102 may integrate the winning bid with a system such as an automatic installation or update service to direct the installation of the application and/or presentation of the application icon at the location on the display screen of the aggregated end user devices 108.

The operations of FIG. 3 are equally applicable for pre-installation of applications and for later installation of applications on end user devices 108 of the device partners 102. In the case of later installation, either because the application icon placement location is available, has been reserved or because the application icon placement location has become available due to a user removing an application currently occupying the location, the location can be identified for a subsequent selection operation. In this case, the location can be identified for the subsequent selection operation with the exception of a selection operation resulting in the reinstallation of the removed application and/or a related application.

Various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as hard drives, USB (universal serial bus) drives, or any other machine readable storage medium, such that when the computer program code is loaded into and executed by a computer, the computer becomes an apparatus for practicing implementations of the disclosed subject matter. When implemented on a general-purpose microprocessor, the computer program code may configure the microprocessor to become a special-purpose device, such as by creation of specific logic circuits as specified by the instructions.

The disclosed subject matter may also be implemented using hardware that may include a processor, such as a general purpose microprocessor and/or an Application Specific Integrated Circuit (ASIC) that embodies all or part of the techniques according to the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to the disclosed subject matter.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

The illustrated aspects of the disclosure may also be practiced in distributed computing environments where certain tasks are performed by remote processing devices that are linked through a communications network. In a distributed computing environment, program modules can be located in both local and remote memory storage devices.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. In addition, while a particular feature of the subject innovation may have been disclosed with respect to only one of several implementations, such feature may be combined with one or more other features of the other implementations as may be desired and advantageous for any given or particular application.

Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements. Moreover, use of the term “an embodiment” or “one embodiment” throughout is not intended to mean the same embodiment unless specifically described as such. The terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component.

One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof. The words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The foregoing description, for purpose of explanation, has been described with reference to specific implementations. However, the illustrative discussions above are not intended to be exhaustive or to limit the disclosed subject matter to the precise forms disclosed. Many modifications and variations are possible in view of the above teachings. The implementations were chosen and described in order to explain the principles of the disclosed subject matter and their practical applications, to thereby enable others skilled in the art to utilize those implementations as well as various implementations with various modifications as may be suited to the particular use contemplated.

1. A method for managing installation of applications on a user device, comprising:
identifying a plurality of user devices for application installation;
aggregating the plurality of user devices into a group of devices having a common attribute for installation of an application on each of the plurality of devices in the aggregated group of user devices;
performing a selection operation between a plurality of application providers to select a first application from among applications identified by the application providers for installation on the aggregated user devices, each application provider identifying an application that is proposed for installation on each of the plurality of devices in the aggregated group of user devices; and
installing the first application on each of the aggregated user devices in the aggregated group of user devices in response to the selection operation.

2. The method of claim 1, further comprising:
receiving an acquisition payment from the application provider in response to the selection operation; and
directing a portion of the acquisition payment from the application provider to a device partner of at least one device in the aggregated group of user devices.

3. The method of claim 2, further comprising:
directing the device partner to install the application on the at least one device in response to the selection operation.

4. The method of claim 1, further comprising:
dividing a screen display of the user devices into a plurality of screen display locations; and
performing the selection operation between a plurality of application providers for presentation of an application icon at a first screen display location selected from among the plurality of screen display locations, on the aggregated user devices.

5. The method of claim 4, wherein the screen display locations are identified based upon software installed on the plurality of user devices.

6. The method of claim 4, wherein the common attribute is at least one selected from the group of: an available screen display location, a user profile aspect, and a device type.

7. The method of claim 1, wherein the selection operation comprises an auction in which the plurality of application providers bid for application installation on the aggregated user devices.

8. The method of claim 1, further comprising:
detecting a removal of a second application on a user device;
performing the selection operation for the first application as a replacement of the second application on the user device; and
restricting, from the selection operation, the second application.

9. The method of claim 1, further comprising:
detecting a preference attribute for the user device;
performing the selection operation for the first application installation on the user device; and
restricting from the selection operation an application lacking the attribute.

10. A device for managing installation of applications on a user device, comprising:
an aggregator, configured to identify a plurality of user devices for application installation and aggregate the plurality of user devices into a group of devices having a common attribute for installation of an application on each of the plurality of devices in the aggregated group of user devices; and
a selection operation platform, configured to perform a selection operation between a plurality of application providers to select a first application from among applications identified by the application providers for installation on the aggregated user devices, each application provider identifying an application that is proposed for installation on each of the plurality of devices in the aggregated group of user devices, and direct an installation of the first application on each of the aggregated user devices in the aggregated group of user device in response to the selection operation.

11. The device of claim 10, wherein the device is further configured to receive an acquisition payment from the application provider in response to the selection operation and direct a portion of the acquisition payment from the application provider to a device partner of at least one device in the aggregated group of user devices.

12. The device of claim 11, wherein the device is further configured to direct the device partner to install the application on the at least one device in response to the selection operation.

13. The device of claim 11, wherein the device is further configured to retain a portion of the acquisition payment from the application provider.

14. The device of claim 10, wherein:
the aggregator is further configured to identify a plurality of screen display locations of the user devices; and
the selection operation platform is further configured to perform the selection operation between a plurality of application providers for presentation of an application icon at a first screen display location selected from among the plurality of screen display locations, on the aggregated user devices.

15. The device of claim 14, wherein the common attribute is at least one selected from the group of: an available screen display location, a user profile aspect, and a device type.

16. The device of claim 10, wherein the selection operation comprises an auction in which the plurality of application providers bid for application installation on the aggregated user devices.

17. The device of claim 10, wherein:
the aggregator is further configured to detect a removal of a second application on a user device; and
the selection operation platform is configured to perform the selection operation for the first application as a replacement of the second application on the user device and restrict, from the selection operation, the second application.

18. The device of claim 10, wherein:
the aggregator is further configured to detect a preference attribute for the user device; and
the selection operation platform is configured to perform the selection operation for the first application installation on the user device and restrict, from the selection operation, an application lacking the attribute.

19. A non-transitory computer-readable storage medium containing instructions that, when executed, control a device to be configured for:
identifying a plurality of user devices for application installation and aggregating the plurality of user devices into a group of devices having a common attribute for installation of an application on each of the plurality of devices in the aggregated group of user devices; and
performing a selection operation between a plurality of application providers to select a first application from among applications identified by the application providers for installation on the aggregated user devices, each application provider identifying an application that is proposed for installation on each of the plurality of devices in the aggregated group of user devices, and directing an installation of the first application on each of the aggregated user devices in the aggregated group of user device in response to the selection operation.

20. The non-transitory computer-readable storage medium of claim 19, further containing instructions that, when executed, control the device to be configured for:
receiving an acquisition payment from the application provider in response to the selection operation and directing a portion of the acquisition payment from the application provider to a device partner of at least one device in the aggregated group of user devices.

21. The non-transitory computer-readable storage medium of claim 20, further containing instructions that, when executed, control the device to be configured for:
directing the device partner to install the application on the at least one device in response to the selection operation.

22. The non-transitory computer-readable storage medium of claim 20, further containing instructions that, when executed, control the device to be configured for retaining a portion of the acquisition payment from the application provider.

23. The non-transitory computer-readable storage medium of claim 19, further containing instructions that, when executed, control the device to be configured for:
identifying a plurality of screen display locations of the user devices and performing the selection operation between a plurality of application providers for presentation of an application icon at a first screen display location selected from among the plurality of screen display locations, on the aggregated user devices.

24. The non-transitory computer-readable storage medium of claim 19, further containing instructions that, when executed, control the device to be configured for:
detecting a removal of a second application on a user device and performing the selection operation for the first application as a replacement of the second application on the user device and restricting, from the selection operation, the second application.

25. The non-transitory computer-readable storage medium of claim 19, further containing instructions that, when executed, control the device to be configured for:
detecting a preference attribute for the user device and performing the selection operation for the first application installation on the user device and restricting, from the selection operation, an application lacking the attribute.
